(19) United States
(12) Patent Application Publication
(10) Pub. No.: US 2026/0095251 A1
(43) Pub. Date: Apr. 2, 2026

(54) DATA TRANSMISSION UNIT FOR A VEHICLE INTERIOR, SYSTEM FOR TRANSMITTING DATA IN A VEHICLE INTERIOR, AND AN AIRCRAFT

(71) Applicant: Airbus Operations GmbH, HAMBURG (DE)

(72) Inventor: Sven-Olaf BERKHAHN, HAMBURG (DE)

(21) Appl. No.: 19/337,209

(22) Filed: Sep. 23, 2025

(30) Foreign Application Priority Data
Sep. 27, 2024 (DE) 102024128051.4

(51) Int. Cl. H04B 10/114; G01S 17/42

(52) U.S. Cl. CPC H04B 10/114; G01S 17/42

(57) ABSTRACT

A data transmission unit for a vehicle interior, in particular for an aircraft interior, with at least one LiFi unit, at least one ToF unit, and a control unit coupled thereto, with a control program for controlling the respective functionalities of the components. The components are designed to transmit respective light signals for their respective functionalities via a common light source module. In addition, a system for transmitting data in a vehicle interior, and an aircraft.

### CROSS-REFERENCE TO RELATED APPLICATIONS

This application is a national phase of German Patent Application No. 10 2024 128 051.4 filed on Sep. 27, 2024, the entire disclosure of which are incorporated herein by way of reference.

### FIELD OF THE INVENTION

The present invention relates to a data transmission unit for a vehicle interior, in particular for an aircraft interior, a system for transmitting data in a vehicle interior, in particular in an aircraft interior, and an aircraft with either at least one data transmission unit according to the invention or a system according to the invention.

### BACKGROUND OF THE INVENTION

Data transmission technologies are required for a wide variety of reasons and in many different areas. In spatially limited areas in particular, local radio networks such as WLAN based on the IEEE 802.11 family standard or similar are predominantly used today. Such technologies are also used in vehicle interiors in this context to transmit data from a transmitting unit to a large number of end devices located in the vehicle interior.

Local wireless networks are often limited to two frequency bands (2.4 GHZ or 5 GHZ). The latest developments are characterized by the fact that maximum transmission rates of up to 9.6 Gbit/s can be achieved.

Local radio networks use radio waves to transmit data or data packets between a transmitting unit and a respective terminal device, wherein physical obstacles within the radio radius of the transmitting unit do not generally lead to any significant deterioration in data transmission rates. One disadvantage of this is that radio signals can also be received outside of defined indoor areas, which could be problematic, especially when transmitting sensitive data.

Taking the latter point in particular into account, data transmission technologies based on the use of light signals are becoming increasingly interesting. LiFi technology (derived from the English technical term “Light Fidelity”) is an optical wireless technology that uses modulated light signals to transmit data. In theory, the entire spectrum of light can be used, although known applications are limited to visible light or infrared radiation. In addition to the wider choice from the aforementioned spectrum, data transfer rates of up to 100 Gbit/s are also possible.

The use of LiFi-based technologies in vehicle interiors can be complex, as an interference-free connection area is essential for the smooth transmission of data or data packets. Non-transparent objects or people represent natural barriers that can block the data stream from light signals. Additional systems for monitoring barrier-free transmission paths would not only incur additional costs, but would also sometimes be impossible to install or provide in an already limited vehicle interior due to insufficient space.

### SUMMARY OF THE INVENTION

Against this background, it is an objective of the present invention to provide a data transmission unit for a vehicle interior, in particular for an aircraft interior, and a system for transmitting data in a vehicle interior, which at least partially overcome the aforementioned disadvantages.

This object is achieved by a data transmission unit with the features of one or more embodiments herein and a system with the features of one or more embodiments herein.

According to the invention, a data transmission unit for a vehicle interior, in particular for an aircraft interior, is provided, which comprises at least one LiFi unit, at least one ToF unit and a control unit coupled to each of these components with a control program for controlling the respective functionalities of these components. The at least one LiFi unit and the at least one ToF unit are designed to transmit respective light signals for their respective functionalities via a common light source module.

Furthermore, according to the invention, a system for transmitting data in a vehicle interior, in particular in an aircraft interior, is provided, which comprises at least two data transmission units according to the invention, wherein respective control units with control programs are designed evaluate at least two consecutive ToF unit pieces of information collected by respective ToF units by means of a comparison with a system-internal or external database of ToF unit information and LiFi unit information coupled to the system, so that possible coverings of data transmission signals of the respective LiFi units can be detected at an early stage and so that optimum data transmission rates of the system can be achieved by means of the respective LiFi units.

Furthermore, according to the invention, an aircraft is provided which comprises at least one data transmission unit or one system according to the invention.

One idea behind the present invention is therefore to provide a data transmission unit and a system by means of which data can be transmitted quickly and reliably within a vehicle interior. In order to achieve fast data transmission, LiFi technology is used. At the same time, the respective devices, data transmission unit and system, the ToF technology is combined in such a way that, on the one hand, it is compact and space-saving by providing a common light source module with LiFi technology, and at the same time, it creates the possibility of monitoring the transmission path between the transmitting light source module and possible receiving devices in the light cone of the devices, so that appropriate actions can be triggered if necessary.

A first advantage is therefore that both the data transmission unit and the system according to the invention can be designed to be compact and thus space-saving in a vehicle interior, for example an aircraft interior, since two technologies that were previously provided separately are provided together in one device using the same components, light source module and control unit with control program.

This new concept not only reduces the installation space required in a vehicle, such as an aircraft, but also reduces manufacturing costs, as components for different technical tasks can now be used together. In other words, one of the main advantages is that instead of two separate devices for LiFi and ToF sensors, there is only one device, which means a reduction in costs for production, installation, maintenance, etc.

Another advantage of the combined LiFi/ToF device is the ability to detect potential obstacles in the line of sight between the LiFi access point and the end device that impair LiFi transmission performance. This advantage applies equally to the system according to the invention, which can also be regarded as a complex device comprising at least two data transmission units according to the invention.

The aforementioned advantages also apply, insofar as they are transferable, to the aircraft presented.

According to a further embodiment of the invention, the common light source module comprises at least one light modulation unit and at least one light source unit, and the at least one light source unit is selected from: a modulatable light source unit, an LED unit, a μLED unit, a VCSL unit, and the at least one light modulation unit is selected from: an acousto-optical modulation unit, an electro-optical modulation unit, a polarization modulation unit, an interferometric optical modulation unit, a Mach-Zehnder modulation unit, or a laser beam modulation unit.

Depending on the intended use and nature of the vehicle interior, the appropriate components of the common light source module can thus be selected and arranged in the respective device. In particular, the use of VCSL units with appropriately matched light modulation units can be advantageous for the combined use of LiFi technology and ToF technology, as the respective light signals can thus be provided in a particularly defined and efficient manner.

According to a further embodiment of the invention, the data transmission unit is designed to be functionally integrated into a passenger service unit for a vehicle, in particular an aircraft, and at least one functionality of the passenger service unit can be controlled as a function of a signal sequence from the at least one ToF unit evaluated by the control unit with a control program

The signal sequence of the at least one ToF unit can be regarded as a transmitted light signal and an associated received light signal at the at least one ToF unit. In other words, objects within the light cone of the common light source module are thus detectable within the signal sequences, wherein in this embodiment, this detection of objects, for example in the form of a gesture performed by a person using an arm or a hand, can be used to control at least one functionality of the passenger service unit. One functionality of the passenger service unit may be, for example, switching on a lamp or activating an air flow. Functional integration thus represents a form of coupling between the devices, which is characterized by the fact that information, for example in the form of control commands or the like, can be exchanged between them. In this respect, the passenger service unit and the data transmission unit according to the invention, which are thus coupled, can not only communicate with each other, but also influence each other. In this respect, control sequences or the like can also be triggered at least partially via the passenger service unit at the data transmission unit and vice versa.

According to a further embodiment of the invention, at least one functionality of the at least one LiFi unit is adaptable, at least temporarily, depending on a signal sequence of the at least one ToF unit evaluated by the control unit with a control program.

Beyond the definition of the signal sequence already described, the ToF unit can be used to detect respective objects in the light cone of the common light source module so that possible blockages of a data transmission signal sent by the LiFi unit can be detected.

A temporary adjustment can be, for example, an interruption in the transmission of data, wherein the transmission is resumed as soon as the ToF unit detects that the previously detected blockage has been removed. In the case of multiple LiFi units, a temporary adjustment may also be provided in the selection of a LiFi unit of which the transmission path is currently not blocked or not significantly blocked. Since, according to the invention, the same light source module is provided, a further advantage in this context is that the respective light signals have identical paths, so that possible blockages can be detected very accurately and thus consistently.

In some embodiments of the invention, the common light source module comprises at least one light source unit array.

A light source unit array offers the advantage that different light units can be provided in the array. Furthermore, depending on the size of the array, a corresponding area in the vehicle interior can be covered so that sufficient data can still be transmitted even if partial coverage is detected.

According to a further embodiment of the invention, it is provided that a light cone of the common light source module can be adjusted by the data transmission unit by means of at least one optical unit coupled to the control unit with control program.

In this way, it is possible to widen the light cone in order to supply previously unreachable areas with data transmission. This embodiment can also be advantageously used when, for example, an object blocking the light path is detected. In this case, the optical unit can be used to make an adjustment so that the light cone is widened sufficiently to still effect the desired data transmission.

According to a further embodiment of the invention, the data transmission unit is designed to provide at least one piece of information detected by the ToF unit in a light cone of the common light source module to at least one external device.

The control unit with control program provided in the data transmission unit can be designed for this purpose so that the signal sequences collected by the ToF unit are evaluated in order to ultimately be able to make a statement about a detected object. For example, an empty seat can be detected in this way, wherein this information is then made available to another external device, such as a flight attendant panel or the like, for further use.

According to a further embodiment of the invention, it is provided that respective light signals for respective functionalities of the at least one LiFi unit and the at least one ToF unit differ at least in terms of their flashing frequency or their duty cycle or their flashing frequency and their duty cycle.

In this way, the shared light source module can be used even more efficiently and an even better assignment of the transmitted light signals from respective receiving devices can be achieved.

According to a further embodiment of the invention, the at least one LiFi unit and the at least one ToF unit are designed to receive respective light signals for their respective functionalities via a common receiving module.

In this way, a more compact data transmission unit can be created. This also makes it possible to ensure even better that respective signals can be provided for substantially the same range. In other words, it is thus possible to detect even more reliably to what extent a transmission path for information to be transmitted is free or not. It also allows for an even faster switch to an alternative transmission method, as the higher reliability enables an even faster response. The common receiving module can be designed as a light/photon receiver unit or similar, which is designed to provide the necessary functionalities for both the LiFi unit and the ToF unit.

According to a further embodiment of the invention, the common light source module and the common receiving module are provided substantially in a single assembly unit.

In this way, the data transmission unit can be designed even more compactly so that it can be installed in a space-saving manner. In addition, further costs can be saved because common components can be used where possible.

### BRIEF DESCRIPTION OF THE DRAWINGS

The present invention is explained in more detail below with reference to the exemplary embodiments shown in the schematic figures:

FIG. 1 shows a schematic view of a data transmission unit according to one embodiment of the present invention;

FIG. 2 shows a schematic view of an alternative data transmission unit according to an embodiment of the present invention;

FIG. 3 shows a schematic view of a system for transmitting data in a vehicle interior according to an embodiment of the present invention;

FIG. 4 shows a schematic view of an aircraft with a data transmission unit according to an embodiment of the present invention;

FIG. 5 shows a schematic view of an aircraft with a system according to an embodiment of the present invention.

In the figures of the drawing, identical elements, features and components with the same function and effect are each assigned the same reference signs, unless otherwise specified.

### DETAILED DESCRIPTION OF THE PREFERRED EMBODIMENTS

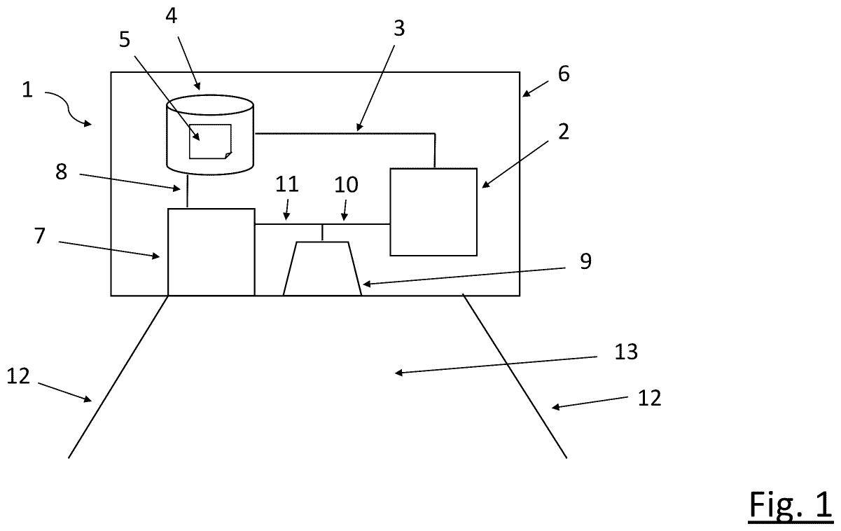

FIG. 1 shows a schematic view of a data transmission unit 1 according to an embodiment of the present invention. In this simple embodiment of the data transmission unit 1, only a LiFi unit 2 is provided, which is shown coupled via a first connecting line 3 to a control unit 4 with a control program 5. The aforementioned components of the data transmission unit 1 are shown arranged in a housing 6. The arrangement within the housing 6 can be designed variably for these aforementioned components, wherein a maintenance-friendly arrangement is advantageous. A maintenance-friendly arrangement can be characterized, for example, by the fact that the aforementioned components are arranged and placed in such a way that they can be easily replaced. The control unit 4 with control program 5 can, for example, be provided as a CPU/FPGA/ASIC processor unit with corresponding software in order to save not only costs but also weight and space, i.e., installation space.

In further embodiments not described in detail, it is conceivable that more than one LiFi unit 2 is provided. For example, two or more LiFi units 2 may be provided. The respective LiFi units 2 each serve as LiFi access points to enable wireless transmission of data to possible end devices. Such end devices can be, for example, laptops, mobile phones, tablets or the like. Non-mobile end devices installed in the vehicle interior are also conceivable as receivers of the transmitted data. These can be, for example, entertainment units in an aircraft or other vehicle, which are integrated, for example, into the backrests of vehicle seats. It is conceivable that further components of the LiFi unit 2 are provided within the housing 6, for example at a lower edge of the housing 6, in particular in recesses of the housing 6 provided for this purpose, in order to receive signals introduced from outside, for example.

The control unit 4 with control program 5 is also shown as being coupled to a ToF unit 7 via a second connecting line 8.

The control unit 4 with control program 5 is designed to control the respective functionalities of these components, the LiFi unit 2 and the ToF unit 7. The control program 5 may comprise pre-written programs or may also be user-definable and customizable. Any hybrid solutions between these two extremes are also conceivable.

The ToF unit 7 is shown arranged at a lower boundary of the housing 6 in relation to the image plane, so that a sensor unit of the ToF unit 7, which is not shown in detail, can detect correspondingly reflected light signals from outside the housing 6. Light signals initially emitted by the ToF unit 7 and subsequently detected by the ToF unit 7 as reflected light signals can be regarded as a signal sequence of the ToF unit 7. This sensor unit, which is not shown in detail, can be, for example, a photodiode, a photosensor or the like.

Both the LiFi unit 2 and the ToF unit 7 are also shown as being coupled to a shared light source module 9 via a third connecting line 10 and a fourth connecting line 11, respectively. In this respect, the light source module 9 shown is used equally by these two units 2 and 7. In other words, both the LiFi unit 2 and the ToF unit 7 are designed to transmit respective light signals for their respective functionalities via this shared light source module 9. Dashed lines 12 below the housing 6 indicate an area in which the light cone 13 of the light source module 9 radiates.

The light source module 9 comprises light source units and corresponding light modulation units, which are not shown in detail. Embodiments are conceivable which each comprise only one unit of these components. In further embodiments not shown in detail, however, two light source units and a common light modulation unit may also be provided in each case. It is also conceivable that different selections of the respective light source modules and light modulation units are combined.

In the event that more than two LiFi units 2 are provided, it is conceivable that data transmission is effected in parallel via the two LiFi units 2, wherein it is also conceivable that the light source module 9 comprises respective light source units which are assigned to respective LiFi units 2. In the event that light signals originating from one of these light source units are blocked by an obstacle and data transmission cannot therefore take place, this circumstance can be detected in accordance with the basic idea of the invention presented by means of respective ToF units 7 in order to then continue data transmission via another LiFi unit 2. Since a common light source module 9 with a corresponding light cone is provided for both the LiFi units 2 and the ToF units 7, the respective states of data transmission paths can be detected at an early stage, so that improvements in data transmission can be effected and smooth data transmission via the transmitted light signals is possible. The data to be transmitted can be provided by external devices that are appropriately coupled to the data transmission unit 1. In an aircraft, such an external device can be provided, for example, in the form of a cabin data server or the like, wherein the data can then be provided, for example, in the form of film files and/or audio files (streaming), magazines, web surfing, etc.

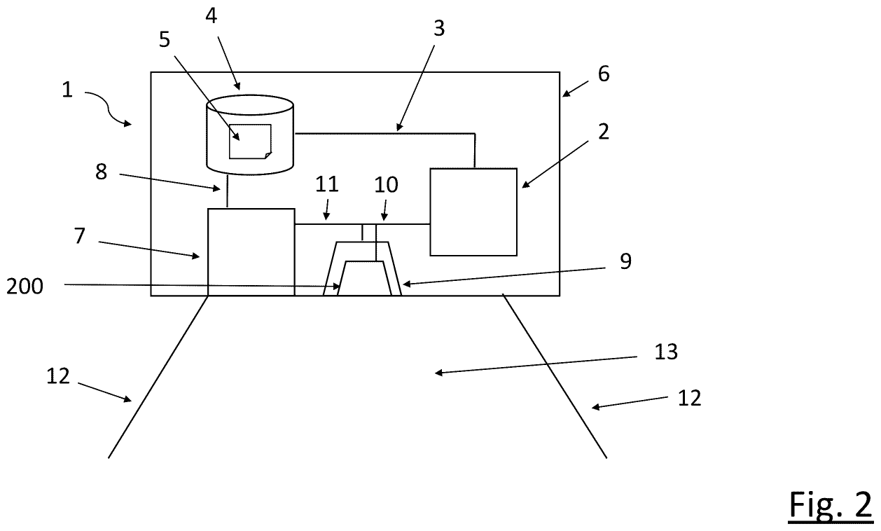

FIG. 2 shows a schematic view of an alternative data transmission unit 1 according to one embodiment of the present invention.

This data transmission unit 1 is substantially identical in construction to that shown and described in FIG. 1, so that like components with like reference signs are not reintroduced here. The only difference is that the data transmission unit 1 shown in FIG. 2 additionally has a common receiving module 200. This common receiving module 200 is substantially provided at the same location within the data transmission unit 1 where a shared light source module 9 is provided.

Both the LiFi unit 2 and the ToF unit 7 are shown as being coupled to the common receiving module 200 via a third connecting line 10 and a fourth connecting line 11, respectively.

In a variant not shown in detail, it is conceivable that the shared receiving module 200 and the shared light source module 9 are substantially provided in an assembly unit.

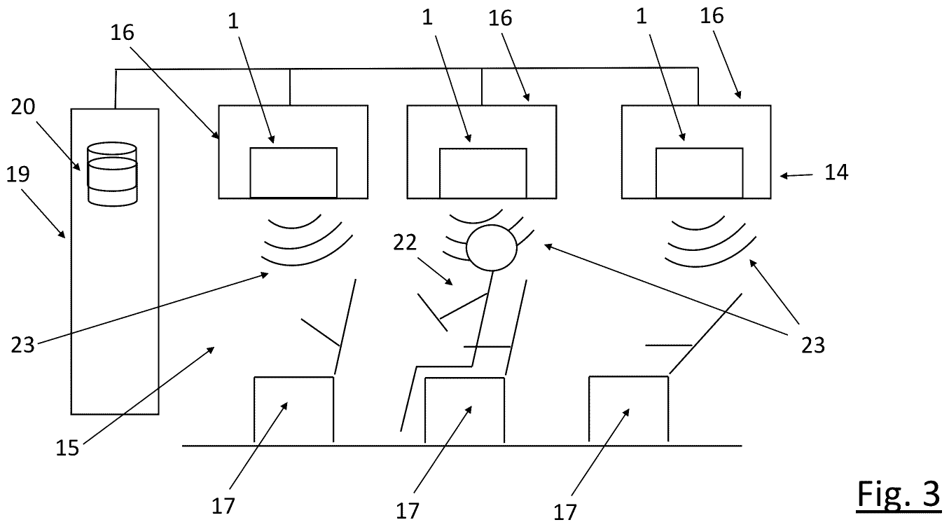

FIG. 3 shows a schematic view of a system 14 for transmitting data in a vehicle interior according to one embodiment of the present invention. In this case, the vehicle interior is an aircraft interior 15 for passengers. A total of three data transmission units 1 are shown in system 14, each of which may correspond, for example, to the data transmission units 1 shown in FIG. 1. It is therefore conceivable that these are three identical data transmission units 1.

In an embodiment not shown in detail, however, it is conceivable that these are differently designed data transmission units 1, which, for example, comprise a differently modified light source module 9 depending on the location of use.

FIG. 3 shows the respective data transmission units 1 in respective passenger service units 16 above respective aircraft seats 17. The passenger service units 16 may, for example, have conventional functions for passengers in an aircraft interior 15, such as a user-adjustable ventilation system, reading lights, service call buttons and the like, which are not described in detail. In this context, it is conceivable that the aircraft seats 17 are respective rows of seats in the aircraft interior 15, in which case a respective passenger service unit 16 is provided above each seat, which in turn has a respective data transmission unit 1 of the system 14 integrated therein according to the invention.

In FIG. 3, the passenger service units 16 and the data transmission units 1 of the system 14 are shown coupled to a central aircraft cabin data server 19 via a fifth connecting line 18. It is conceivable, for example, that the data to be transmitted via the respective data transmission units 1 is available in this aircraft cabin data server 19 and can be accessed either directly or via the respective passenger service units 16 or even via IFE units (IFE=in-flight entertainment) and made available for data transmission to the respective data transmission units 1.

In the embodiment of the system 14 shown in FIG. 3, an associated database 20 is provided integrated in the aircraft cabin data server 19. This database 20 is a database containing ToF unit information and LiFi unit information.

LiFi unit information can, for example, be any data related to the intended data transmission using light signals.

ToF unit information can be stored in conjunction with objects to be detected or with the movements of passengers' body parts. For example, an object can be an aircraft seat 17 in its basic position or in its basic position with at least one angled armrest 21. A typical movement of a body part of a passenger 22 may be, for example, a typical arm movement that the passenger 22 performs in order to reach for a drink placed in front of them and then bring it to their mouth, before placing it back in its intended location. The posture of a passenger 22 holding a book or tablet, as shown in the center of FIG. 3, can also be stored in the database 20 as ToF information.

If objects or movements are detected by the respective ToF units 7 of the data transmission units 1 of the system 14, a comparison with the database 20 can be used to detect at an early stage whether an impairment of a data transmission path of a specific LiFi unit 2 is to be expected. In this case, provided that alternative LiFi units 2 cover at least part of the same area, the system 14 can then continue data transmission with another LiFi unit 2 of the system 14.

In other words, possible coverages of data transmission signals, shown in FIG. 3 by respective light wave symbols 23, of the respective LiFi units 2 can be detected at an early stage, so that optimum data transmission rates of the system 14 can be achieved by means of the respective LiFi units 2.

An overlapping arrangement of data transmission signals from neighboring data transmission units 1 is just as conceivable as an overlap of respective light source units in the respective light source modules 9.

In the event that an optical unit, which is not shown in detail, coupled to a respective control unit 4 with a control program 5 is provided by the data transmission unit 1, it is also conceivable that a changing area of a light cone by means of the optically controlled unit ensures that sufficient light signals are transmitted past the detected obstacle so that data transmission can still take place.

In other words, LiFi data throughput is impaired in the event of a blockage/impairment of the line of sight. This can manifest itself, for example, in a decreasing data rate or a declining data rate. By detecting potential impairments to the line of sight at an early stage, LiFi performance can be improved by proactively transferring data communication to the next neighboring LiFi access point (LiFi unit 2) at an early stage, rather than reactively transferring it when the LiFi data connection fails. In a variant not described in detail, proactive transfer can either take place decentrally between the passenger service units 16/LiFi access points (LiFi units 2) or be managed by the central flight cabin data server 19. In a further embodiment, it is also conceivable to control the respective data transmission units 1.

Obstacle detection can improve the handover from one LiFi unit 2 to another LiFi unit 2, such as the next data transmission unit 1 or a LiFi unit 2 in the same data transmission unit 1, by detecting the obstacle movement before the line of sight is interrupted by the obstacle.

However, a separate, stand-alone location for this database 20 is also conceivable. It is also conceivable that this database 20 is not stored in the aircraft cabin data server 19, but in one of the data transmission units 1 of the system 14. It is also conceivable that part of the database 20 is stored in the data transmission units 1 and part either in the aircraft cabin data server 19 or even additionally via corresponding connection technologies outside the aircraft 100.

In addition, the system 14 shown offers further functions. The ToF part, i.e., the respective ToF units 7 of the combined device, i.e., the respective data transmission units 1 of the system 14, observes the environment of the associated sensors (the light source modules 9). It can be used for gesture control of the passenger service unit 16, such as reading light on/off, bright/dim, operation of the service call button, control of the ventilation system, etc.

The ToF sensor, i.e., the ToF unit 7 with the corresponding sensor elements, can also monitor the position of the armrests and backrests of the aircraft seat 17 and whether the aircraft seat 17 is occupied or not. Since the ToF sensor has only a very limited pixel resolution, it can be used for object/passenger detection without affecting the General Data Protection Regulation (no face recognition/identification possible).

The information from the gesture control and passenger service unit control can be processed locally in the passenger service unit 16 or in the respective control units 4 with control program 5, for example. The information on seat status (arm rest, backrest, occupied or not) can be sent to the central flight cabin data server 19 and stored there for corresponding evaluation steps by the cabin crew. The information can be further processed by displaying it to the cabin crew via a (wireless) flight attendant panel or by sending it from there to any ground server for further processing (big data analysis, turnaround monitoring, etc.).

The ToF sensor (ToF unit 7) can also detect whether the line of sight for wireless LiFi data communication between the LiFi unit 2 in the passenger service unit 16 and a possible end device (mobile PAX or crew device, in-flight entertainment screen at the seat, etc.) is blocked, for example by the heads of passengers 22 or other obstacles.

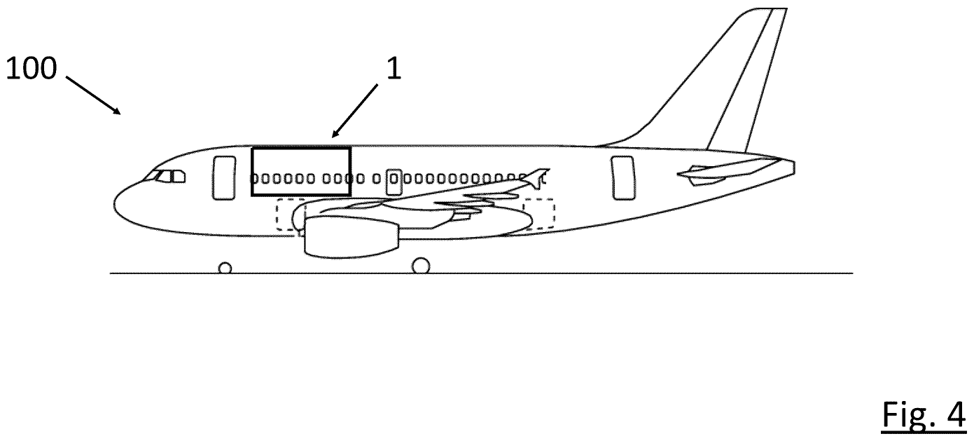

FIG. 4 shows a schematic view of an aircraft 100 with a data transmission unit 1 according to one embodiment of the present invention.

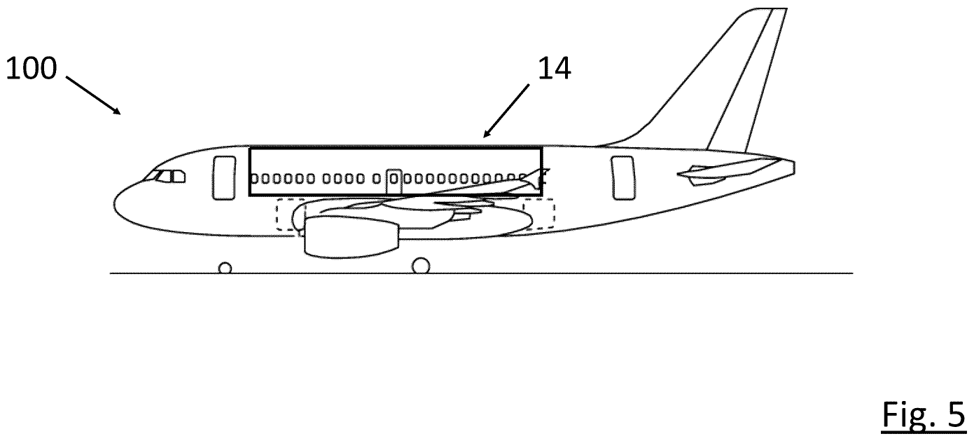

FIG. 5 shows a schematic view of an aircraft 100 with a system 14 according to an embodiment of the present invention.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 data transmission unit
2 LiFi unit
3 first connecting line
4 control unit
5 control program
6 housing
7 ToF unit
8 second connecting line
9 light source module
10 third connecting line
11 fourth connecting line
12 dashed line
13 light cone
14 system
15 aircraft interior
16 passenger service unit
17 aircraft seat
18 fifth connecting line
19 aircraft cabin data server
20 database
21 armrest
22 passenger
23 light wave symbol
100 aircraft
200 receiving module

Claimed is:

1. A data transmission unit for a vehicle interior comprising:
at least one LiFi unit;
at least one ToF unit; and
a control unit coupled to the at least one LiFi unit and the at least one ToF unit, the control unit comprising a control program for controlling a respective functionalities of the at least one LiFi unit and the at least one ToF unit,
wherein the at least one LiFi unit and the at least one ToF unit are configured to transmit respective light signals for the respective functionalities via a common light source module.

2. The data transmission unit according to claim 1, wherein the common light source module comprises at least one light modulation unit and at least one light source unit,
wherein the at least one light source unit is selected from a group consisting of: a modulatable light source unit, an LED unit, a μLED unit, and a VCSL unit; and
wherein the at least one light modulation unit is selected from a group consisting of: an acousto-optic modulation unit, an electro-optic modulation unit, a polarization modulation unit, an interferometric optical modulation unit, a Mach-Zehnder modulation unit, and a laser beam modulation unit.

3. The data transmission unit according to claim 1, wherein the data transmission unit is configured to be functionally integrated into a passenger service unit for the vehicle, and
wherein at least one functionality of the passenger service unit is controlled as a function of a signal sequence from the at least one ToF unit evaluated by the control unit.

4. The data transmission unit according to claim 1, wherein at least one functionality of the at least one LiFi unit is adjusted, at least temporarily, as a function of a signal sequence from the at least one ToF unit evaluated by the control unit.

5. The data transmission unit according to claim 1, wherein the common light source module comprises at least one light source unit array.

6. The data transmission unit according to claim 1, wherein a light cone of the common light source module is configured to be adjusted by the data transmission unit by at least one optical unit coupled to the control unit.

7. The data transmission unit according to claim 1, wherein the data transmission unit is configured to provide at least one piece of information detected by the at least one ToF unit in a light cone of the common light source module to at least one external device.

8. The data transmission unit according to claim 1, wherein light signals for functionalities of the at least one LiFi unit and light signals for functionalities of the at least one ToF unit differ at least in terms of a flashing frequency, or a duty cycle, or a flashing frequency and a duty cycle.

9. The data transmission unit according to claim 1, wherein the at least one LiFi unit and the at least one ToF unit are configured to receive respective light signals for their respective functionalities via a common receiving module.

10. The data transmission unit according to claim 9, wherein the common light source module and the common receiving module are provided in one assembly unit.

11. A system for transmitting data in a vehicle interior, the system comprising:
at least two data transmission units according to claim 1,
wherein respective control units with control programs are configured to evaluate at least two consecutive ToF unit information items collected by the at least one ToF units with a comparison with a system-internal or external database of ToF unit information and LiFi information coupled to the system so that coverings of data transmission signals of the at least one LiFi units is configured to be detected and optimum data transmission rates of the system are with the at least one LiFi units.

12. An aircraft comprising:
at least one data transmission unit according to claim 1.
